(19) United States
(12) Patent Application Publication
(10) Pub. No.: US 2020/0300153 A1
(43) Pub. Date: Sep. 24, 2020

(54) A FAN ARRANGEMENT IN A VEHICLE

(71) Applicant: Scania CV AB, Södertälje (SE)

(72) Inventors: Zoltan KARDOS, Södertälje (SE); Ola HALL, Stockholm (SE)

(21) Appl. No.: 15/779,292

(22) PCT Filed: Dec. 13, 2016
(86) PCT No.: PCT/SE2016/051254

§ 371 Date: May 25, 2018

(30) Foreign Application Priority Data
Jan. 15, 2016 (SE) 1650042-3

(51) Int. Cl. F01P 5/04; F01P 3/18; F01P 5/06; F02M 31/20

(52) U.S. Cl. CPC F01P 5/04; F01P 3/18; F01P 2005/025; F02M 31/20; F01P 2005/046; F01P 5/06

(57) ABSTRACT

A fan arrangement for a cooling module in a vehicle. The vehicle (6) has a radiator fan (10) providing an air flow through a flow passage (5) and the cooling module in an intended flow direction. The cooling module includes a radiator (3) and at least one further cooler (1, 2) arranged in an upstream position of the radiator (3) with respect to the intended flow direction through the flow passage (5). The fan arrangement includes at least one additional electrically driven fan (4). The additional electrically driven fan (4) is arranged in the flow passage (5) in a position downstream of the radiator (3) and upstream of the radiator fan (10) with respect to the intended flow direction through the flow passage (5). The electrically driven fan (4) is configured to provide an air flow through a restricted portion (18) of the flow passage (5) and the cooling module during certain occasions when the operating conditions include the radiator fan not being in operation.

### CROSS-REFERENCE TO RELATED APPLICATIONS

The present application is a 35 U.S.C. §§ 371 national phase conversion of PCT/SE2016/051254, filed Dec. 13, 2016, which claims priority of Swedish Patent Application No. 1650042-3, filed Jan. 15, 2016, the contents of which are incorporated by reference herein. The PCT International Application was published in the English language.

### BACKGROUND OF THE INVENTION AND PRIOR ART

### Technical Field

The present invention relates to a fan arrangement in a vehicle.

### Technical Background

An AC system is commonly used to cool the cab space in a vehicle. AC systems comprise a cooling circuit with a circulating refrigerant. The circulating refrigerant cools the air in the cab space when it vaporizes in an evaporator and gives off heat to surrounding air when it condenses in a condenser. The condenser is usually situated at the front portion of the vehicle near to the radiator in which the coolant in the engine's cooling system is cooled. During operation, air is drawn through the condenser and the radiator by a radiator fan driven by the engine. The engine also drives a compressor which compresses and circulates the refrigerant in the AC system.

It is often desired to use the AC system in the vehicle even at times when the engine is not running. A known practice in this respect is to run the compressor on electrical energy and use an electrically driven fan to force a cooling air flow through the condenser. However, there is usually no space for an electrically driven fan in a position close to the ordinary condenser. AC systems are known to be equipped with an additional condenser and an electrically driven fan located at a distance from the ordinary condenser for operation of the AC system when the engine is not running.

The existence of two condensers increases the number of components of the AC system at the same time as it complicates the operation of the AC system. The amount of air which can be supplied to a supercharged combustion engine depends on the pressure of the air but also on the temperature of the air. Therefore, the charged air is cooled in a charged air cooler before it is enters the combustion engine. The charged air cooler may be arranged at a front portion of a vehicle where it is cooled by ambient air. When ambient air has a low temperature, the charged air can be cooled to a temperature below the dew point temperature of the air. In this case, liquid water is formed in the charge air cooler. When ambient air temperature is below 0° C., there is also risk that the liquid water freezes to ice in the charge air cooler. Such ice formation will cause a greater or lesser amount of obstruction of the airflow ducts within the charge air cooler, resulting in a reduced flow of air to the combustion engine and consequent operational malfunctions or stoppages.

DE 10 2011 006 350 A1 shows a fan arrangement for moving cool air into an air path through a cooling module. The fan arrangement comprises a fan shroud including a main fan driven by an engine and a number of electrically driven fans arranged in parallel to the main fan. The electrically driven fans provide complementary air paths at the side of a main air path provided by the main fan. Such a positioning of the electrically driven fans is space consuming since it requires a wider flow channel in order to accommodate the electrically driven fans.

### SUMMARY OF THE INVENTION

The object of the present invention is to add at least one electrically driven fan to a radiator fan in a vehicle where the existence of the additional electrically driven fan does not require any extra space in the vehicle.

The above mentioned object is achieved by the fan arrangement according to the invention. A cooling module in a vehicle may comprise a radiator and at least one other cooler defined as a further cooler. During certain occasions, it is desired to provide an air flow through the further cooler when the radiator fan is not in operation. However, it is a problem to find a suitable mounting position for such an additional fan. The area in front of the further cooler is usually occupied by a grille. The area behind the further cooler is usually occupied by the radiator or another cooler. However, there is usually an empty space between the radiator and the radiator fan inside the fan shroud where it is possible to arrange an additional electrically driven fan. In this case, the additional electrically driven fan is not positioned adjacent to the further cooler but it is possible to provide an air flow through the radiator and the further cooler by the additional fan. The fan and the electrical engine may be mounted as a unit in this empty space.

According to an embodiment of the invention, the electrically driven fan is arranged in the flow passage in a position closer to the radiator than to the radiator fan. A positioning of the additional electrically driven fan adjacent to the radiator makes it easier to provide a relatively concentrated air flow through the radiator and the further cooler on the opposite side of the radiator. The additional electrically driven fan may be arranged in a part of the flow passage defined by a fan cover of the radiator fan. A radiator fan is usually provided with a fan cover in order to provide an efficient air flow through the radiator fan. Such a fan cover provides an empty space in front of the radiator fan where it is possible to arrange one or several additional electrically driven fans.

According to an embodiment of the invention, the fan arrangement comprises at least one component configured to provide an air channel defining the restricted portion of the flow passage. It is desired to use a relatively small additional fan which does not require a large supply of electrical energy. As a consequence, the additional electrically driven fan is not able to provide an air flow through the entire flow passage and through the entire cooling module. By means of an air channel within the flow passage, it is possible to provide a concentrated air flow through a relevant part of the further cooler by means of a relatively small additional fan. The air channel may be defined by an annular element arranged in a space between the further cooler and the radiator. In this case, it is possible to provide a substantially leak free air flow between the further cooler and the additional fan via the radiator. The annular element may be manufactured of a suitable plastic material. Preferably, the annular element is attachable to the further cooler and the radiator. The annular elements may be provided with projecting fastening portions which are attachable in the flow channels of the cooler/radiator.

According to an embodiment of the invention, the cooling module may comprise two further coolers. The further coolers may be a condenser of an AC system, a charged air cooler, an EGR cooler, oil cooler etc. The air channel may be defined by an annular element arranged in a space between the two further coolers. Also in this case, the annular element may include a fastening portion for attachment to the respective cooler. In this case, it is possible to provide a substantially leak free air flow by the additional fan between the two further coolers. The air channel may be defined by a fan cover of the additional electrically driven fan. Such a fan cover may define a substantially leak free part of the air channel between the radiator and the additional electrically driven fan.

According to an embodiment of the invention, the further cooler is a condenser of an AC system and the electrically driven fan is configured to provide an air flow through the restricted portion of the flow passage and the condenser of the AC system during occasions when the AC system is in operation and the combustion engine is not running. In this case, it is possible to use the AC system when the engine is not running. The additional electrical driven fan and the compressor of the AC system are driven by electric energy from a battery in the vehicle.

According to an embodiment of the invention, the additional electrically driven fan is able to provide an air flow through the restricted portion of the flow passage in an opposite direction to the intended flow direction through the flow passage. Such an additional electrically driven fan may be reversible in its direction of rotation such that it is also able to provide an air flow in the intended flow direction of the flow passage.

According to an embodiment of the invention, the further cooler may be a charge air cooler for cooling charge air delivered to the combustion engine, wherein the additional electrically driven fan is configured to provide an air flow through the restricted portion of the flow passage and the charge air cooler in the direction opposite to the intended flow direction through the flow passage during an occasion when there is risk for ice formation in the charge air cooler. In this case, it is possible to direct relatively warm air from the engine room of the vehicle to the charged air cooler in order to melt possible ice formations in the charge air cooler.

### BRIEF DESCRIPTION OF THE DRAWING

In the following a preferred embodiment of the invention is described, as an example, with reference to the attached drawings, in which:

FIG. 1 shows a front view of a cooling module in a vehicle comprising a fan arrangement according the invention and

FIG. 2 shows a schematic cross-sectional view of the cooling module in the plane A-A in FIG. 1.

### DETAILED DESCRIPTION OF A PREFERRED EMBODIMENT OF THE INVENTION

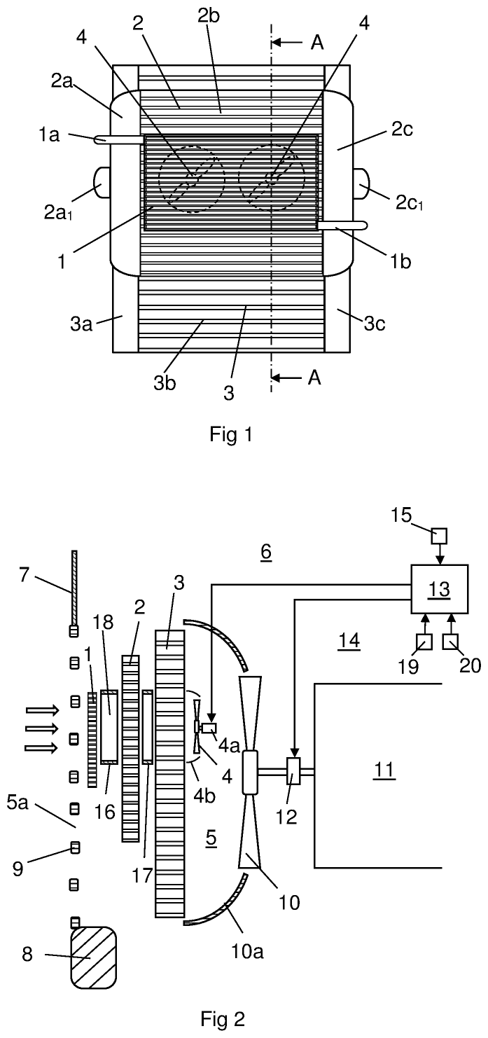

FIG. 1 shows a front view of a cooling module. The cooling module comprises a condenser 1 of an AC system in a front position. The condenser 1 receives a gaseous refrigerant via an inlet line 1a. The refrigerant is cooled in the condenser 1 by a cooling air flow to a temperature at which it condenses. The liquefied refrigerant leaves the condenser 1 via an outlet line 1b. A charge air cooler 2 is arranged in a position behind, that is normally located downstream of, the condenser 1. The charge air cooler 2 comprises an inlet tank 2a, a cooling portion 2b and an outlet tank 2c. Charged air is delivered to the inlet tank 2a via an inlet conduit 2a₁. The charged air is cooled in the cooling portion 2b by a cooling air flow. The cooled charged air is received in the outlet tank 2c before it leaves the charge air cooler 2 via an outlet conduit 2c₁. A radiator 3 is arranged in a position behind the charge air cooler 2. The radiator 3 comprises an inlet tank 3a, a cooling portion 3b and an outlet tank 3c. Coolant is received in the inlet tank 3a. The coolant is delivered to the cooling portion 3b where it is cooled by a cooling air flow. The cooled coolant is received in the outlet tube 1c before it leaves the radiator 3. Two additional fans 4 are indicated with dotted lines. The additional fans 4 are arranged behind the radiator 3. The additional fans 4 are operated by means of a respective electric engine 4a. The fans 4 and the electric engine 4a are mounted as a unit in a position close to the radiator 3. The fans 4 and the electrical engines 4a may be mounted by means of suitable mounting profiles attached to the inlet tank 3a and the outlet tank 3c of the radiator 3.

FIG. 2 shows a cross-sectional view in the plane A-A in FIG. 1. The condenser 1, the charge air cooler 2 and the radiator 3 is arranged in a flow passage 5 in a vehicle 6 which may be a heavy vehicle. The flow passage 5 comprises an opening 5a arranged in a front portion of the vehicle 5. A front wall 7 of the vehicle and a bumper 8 defines the opening 5a of the flow passage 5. A grille 9 is arranged in the opening 5a. The grille 9 is, in this case, defined by a number of vertical bars having a parallel extension across the opening 5a of the air passage 5. A radiator fan 10 is configured to provide a cooling air flow through the cooling module in the flow passage 5. The radiator fan 10 is driven by a combustion engine 11 via a clutch 12. A control unit 13 controls the engagement and the disengagement of the clutch 12.

The combustion engine 11 is arranged in an engine room or compartment 14 of the vehicle 6. The control unit 13 receives substantially continuously information from a temperature sensor 15 about the temperature of coolant which is cooled in the radiator 3 and which cools the combustion engine 11. The control unit 13 starts the radiator fan 10 when the coolant has a temperature above a predetermined temperature. During operation, the radiator fan 10 provides an air flow in an intended flow direction through the flow passage 5. The air flow is comprised of ambient air which it directed into the flow passage 5, via the inlet opening 5a. In the flow passage 5, the air flows through the condenser 1, the charge air cooler 2 and the radiator 3. The air flow cools the refrigerant in the condenser 1, the charge air in the charge air cooler 2 and the coolant in the radiator 3.

The condenser 1 is arranged in the flow passage 5 in a position relatively close to the inlet opening 5a and the grille 9. The charge air cooler 2 is arranged at a distance behind the condenser 1. A first annular element 16 is arranged in the space between the condenser 1 and the charge air cooler 2. The first annular element 16 is attached on the condenser 1 and/or the charge air cooler 2. The radiator 3 is arranged at a distance behind the charge air cooler 2. A second annular element 17 is arranged in the space between the charge air cooler 2 and the radiator 3. The second annular element 17 is attached on the charge air cooler 2 and/or the radiator. The first annular element 16 and the second annular element 17 forms together with air flow passages through the condenser 1, air flow passages through the charge air cooler 2, air flow passages through the radiator 3 and a fan cover 4b of the additional fan 4 an air channel 18 in a restricted portion of the flow passage 5. Each additional fan 4 is configured to provide an air flow through such an air channel 18. The control unit 13 controls the activation of the electric engine 4a and the speed of the additional fan 4. The speed of the additional electrically driven fans may be regulated in a stepless manner. The additional fans 4 are reversible in their respective direction of rotation. Thus, it is possible to provide an air flow through the air channel 18 in the intended flow direction through the flow passage 5 and in an opposite direction to the intended flow direction through the flow passage 5.

The use of the additional fans 4 has several applications. When a driver wishes to take a break on a warm day, it is possible to start the AC system when the combustion engine is not in operation. In this case, the driver can indicate start of the AC system by means of a button 19 or the like. When this is indicated, the control unit 13 initiates supply of electrical energy from a battery or the like in the vehicle 6 to a compressor of the AC system and to the electrical engines 4a powering the additional electrically driven fans 4. The additional fans 4 start and they provide an air flow through the respective air channel 18 in the intended flow direction through the air passage 5. Ambient air is sucked into the flow passages 5, via the opening 5a, and through the air channels 18. The air flow through the air channels 18 provides a required cooling of the refrigerant in the condenser 1. The annular elements 16, 17 and the fan cover 4b of the additional fans 4, define a substantially tight air channel 18. By means of such air channels 18, it is possible to provide concentrated air flows through relevant parts of the condenser 1. Substantially the whole air flow provided by the respective additional fans 4 is directed through the condenser 1. As a consequence, it is possible to use additional electrically driven fans 4 with a relatively small capacity. It is usually an empty space in the flow passage 5 in a position between the radiator 3 and the radiator fan 10 which is defined by the radiator fan cover 10a. The additional fans 4 and the electrical engines 4a are arranged in this space. Consequently, the additional fans 4 are arranged in a downstream position of the radiator 3 and in an upstream position of the radiator fan 10 with respect to the intended flow direction through the flow passage 5.

Another application of the additional fans 4, is when the combustion engine is operated and ambient air has a very low temperature. During such occasions, the radiator fan is usually not driven. Since the combustion engine is operated, charge air is directed to the charge air cooler 2. During such occasions, the water vapor in the charge air may be liquefied and frozen in the charge air cooler 2. If that occurs, the supply of charge air to the combustion engine 11 will be reduced and possibly ceased. In order to avoid this risk, the control unit 13 may receive information from a temperature sensor 20 about ambient temperature or the temperature of the charge air leaving the charge air cooler 2. In case the received temperature indicates such a risk, the control unit 13 activates the additional fans 4 such that they provide an air flow in the flow channels 18 in an opposite direction to the above described intended flow direction through the flow passage 5. As a consequence, the additional fan 4 provides an air flow from the engine room 14 and through the air channels 18. The air flows in the air channels 18 are directed through the radiator 3, the charged air cooler 2 and the condenser 1. The air inside the engine room 14 usually has a considerably higher temperature than ambient air since it is in contact with the combustion engine 11. Consequently, relatively hot air flows from the engine room 14 and through the charge air cooler 2 where it melts possible ice formations.

Finally, it is possible to use the additional fans 4 instead of the radiator fan 10 for cooling of the refrigerant in the condenser 1 during certain operating conditions, such as city driving. In city traffic, the ram air flow through the condenser 1 is many times too low for cooling the refrigerant. In this case, it is possible to start the additional fans 4 instead of the radiator fan 10 for cooling the refrigerant in the condenser 1. In case the additional fans 4 are dimensioned for this purpose, it is usually more energy efficient to start them than to start the considerably larger radiator fan 10.

The invention is not restricted to the described embodiment but may be varied freely within the scope of the claims. The cooling module may, for example, comprise a variable number of coolers.

1. A fan arrangement for a cooling module arranged in an air flow passage in a vehicle, wherein
the vehicle comprises a radiator fan configured and operable to be driven by a combustion engine and the radiator fan being configured and operable to provide an air flow in an intended direction through the air flow passage and the cooling module;
the cooling module comprises a radiator of a cooling system configured and operable for cooling the combustion engine, and at least one further cooler arranged in an position upstream of the radiator with respect to the intended flow direction through the flow passage;
an additional electrically driven fan arranged in the flow passage in a position downstream of the radiator and upstream of the radiator fan with respect to the intended flow direction through the flow passage;
the flow passage having a restricted portion; and
the electrically driven fan is configured to provide an air flow through the restricted portion of the flow passage and through the cooling module during occasions when the radiator fan is not in operation;
the electrically driven fan is configured and operable to also provide an air flow through the restricted portion of the flow passage in an opposite direction to the intended flow direction through the flow passage;
the further cooler is a charge air cooler configured and operable for cooling charge air delivered to the combustion engine; and
the electrically driven fan is configured and operable to provide an air flow through the restricted portion of the flow passage and through the charge air cooler in the direction opposite to the intended flow direction through the flow passage.

2. A fan arrangement according to claim 1, wherein the additional electrically driven fan is arranged in the flow passage in a position closer to the radiator than to the radiator fan.

3. A fan arrangement according to claim 1, further comprising:
a fan cover of the radiator fan defining a part of the flow passage; and
the electrically driven fan is arranged in the part of the flow passage defined by the fan cover of the radiator fan.

4. A fan arrangement according to claim 1, further comprising: at least one component configured to provide an air channel defining the restricted portion of the flow passage.

5. A fan arrangement according to claim 1, further comprising an annular element arranged in a space between the further cooler and the radiator; and
the air channel within the flow passage is defined by the annular element.

6. A fan arrangement according to claim 1, wherein the cooling module comprises at least two further coolers.

7. A fan arrangement according to claim 4, wherein the air channel within the flow passage is defined by an annular element arranged in a space between the two coolers.

8. A fan arrangement according to claim 4, further comprising the fan cover of the electrically driven fan is configured to define the air channel within the flow passage.

9. A fan arrangement according to claim 1, further comprising the further cooler comprises a condenser of an AC system, and the electrically driven fan is configured to provide an air flow through the restricted portion of the flow passage and the condenser of the AC system.

10. A fan arrangement according to claim 1, wherein the electrically driven fan is reversible in its direction of rotation.

11. A fan arrangement according to claim 1, wherein the electrically driven fan is operable to provide an air flow through the restricted portion of the intended flow through the flow passage in the direction opposite to the intended flow direction during occasion when there is risk for ice formation in the charge air cooler.

12. A fan arrangement according to claim 9, wherein the driven fan is configured to provide an air flow through the restricted portion of the flow passage and the condenser of the AC system during occasions when the AC system is in operation and the combustion engine is not running.
